(19) United States
(12) Patent Application Publication
(10) Pub. No.: US 2014/0165737 A1
(43) Pub. Date: Jun. 19, 2014

(54) METHOD AND MEASURING DEVICE FOR INVESTIGATING A MAGNETIC WORKPIECE

(71) Applicants: Hans-Gerd Brummel, Berlin (DE); Uwe Linnert, Furth (DE); Carl Udo Maier, Stuttgart (DE); Jochen Ostermaier, Erlangen (DE); Uwe Pfeifer, Berlin (DE)

(72) Inventors: Hans-Gerd Brummel, Berlin (DE); Uwe Linnert, Furth (DE); Carl Udo Maier, Stuttgart (DE); Jochen Ostermaier, Erlangen (DE); Uwe Pfeifer, Berlin (DE)

(73) Assignee: Siemens Aktiengesellschaft, Munchen (DE)

(21) Appl. No.: 14/236,566

(22) PCT Filed: Jul. 25, 2012
(86) PCT No.: PCT/EP2012/064572

§ 371 Date: Jan. 31, 2014

(30) Foreign Application Priority Data
Aug. 2, 2011 (DE) 10 2011 080 282.7

(51) Int. Cl. G01L 1/12

(52) U.S. Cl. CPC G01L 1/12
USPC 73/779

(57) ABSTRACT

A method for investigating a magnetic workpiece (2) comprises the following steps:—measuring internal mechanical stresses on the workpiece (2) without a load;—measuring internal mechanical stresses on the workpiece (2) with a load;—setting up a calibrating function (7) by means of the two measurements for at least one measuring point;—measuring an externally introduced mechanical stress at the at least one measuring point while taking into consideration the calibrating function (7).

The invention relates generally to a method and a measuring device for investigating a magnetic workpiece and in particular to the investigation of the magnetic workpiece for internal mechanical stresses.

Internal mechanical stresses, such as so-called frozen stresses for example, can arise during the manufacture or further processing of workpieces when the workpiece is subject for example to reshaping treatments or exposed to thermal loads due to hardening processes, surface treatments and/or welding operations.

In the measurement of mechanical stresses the accuracy of the measurement results is heavily influenced by the frozen stresses that are permanently present in the material that is to be measured.

In the measurement of the power output of shafts for a power station, for example, magnetoelastic sensors which operate contactlessly cannot be used on account of the frozen stresses. Other types of measurements can be performed up to a certain degree of accuracy only.

It is the object of the invention to simplify the investigation of a magnetic workpiece for internal mechanical stresses.

This object is achieved according to the invention by means of the features of claims 1 and 9 respectively. Advantageous developments of the invention are defined in the dependent claims.

According to a first aspect, the invention relates to a method for investigating a magnetic workpiece, comprising the following steps:
measuring internal mechanical stresses on the workpiece without load;
measuring internal mechanical stresses on the workpiece (2) with load;
generating a calibration function by means of the two measurements for at least one measurement point;
measuring an externally introduced mechanical stress at the at least one measurement point while taking the calibration function into account.

Knowledge of the frozen stresses and their behavior when a load is applied permits high-precision measurement of, for example, the power transmission on shafts in power stations. By means of this method it is possible to achieve measurement accuracies in the order of magnitude of approximately +/−1%. The calibration function is generated for every measurement point because the internal mechanical stresses or frozen stresses change locally. It is possible to consider one or more measurement points or the entire surface of the workpiece; in the latter case the calibration function can include a map. Through knowledge of the internal mechanical stress at the measurement point it is possible to increase the accuracy of the measurement of the externally introduced mechanical stress by correction using the calibration function. The calibration function can contain a plurality of parameters, in which case it is possible to select the parameters that are to be used.

A magnetoelastic sensor can be used for the measurements. A magnetoelastic sensor is based on the measurement of the change in magnetic permeability. This sensor can be used for example as a torque sensor which is able to measure the power transmitted by shafts, for example. A magnetostrictive sensor can also be used.

The calibration function can include a calibration curve. The frozen stress can be easily represented and processed by means of a calibration curve. Thus, the magnitude of the frozen stress can be an offset for each measurement point.

Defects in the material of the workpiece can be identified on the basis of the slope of the calibration curve. Under normal material conditions, for example, the shape of the slope may be constant and linear. If there is a defect in the material, such as a pinhole for example, there is a change in the slope. This can be observed because it is necessary for the forces to be transmitted in spite of the defects, though this can only be effected by the intact material. The stresses in this region are increased as a result and become noticeable due to a change in the slope of the calibration curve. The method is therefore also suitable for material investigation.

Measurements for generating the calibration function can be taken at different temperatures. Particularly when there are major temperature differences in different operating states, a measurement at different temperatures increases the accuracy of the investigation. The calibration function accordingly has a further degree of freedom or a further dimension which permits a more precise setting or adjustment.

Measurements for generating the calibration function can be taken at different positions of a sensor for the measurement. This enables a distance dependence of the sensor to be taken into account and corrected and the accuracy to be increased in a further dimension.

The calibration function can include a map of the internal mechanical stresses. A calibration function or a calibration value such as an offset can be produced by means of the map for each point on the workpiece or else only for a subset. Through knowledge of the frozen or internal stresses of the workpiece or material at each location, an externally introduced mechanical stress can be measured at each point of the workpiece without distortion due to internal stresses.

For the purpose of measuring an externally introduced mechanical stress it is possible to specify the position of a sensor for the measurement, the distance from the workpiece and/or the temperature. All or some of the acquired data or parameters can be used for the measurement of an externally introduced mechanical stress. The acquired data can be input into a controller of a measuring or processing device or into a special measurement computer and used there for correction purposes.

According to a further aspect, the invention relates to a measuring device for investigating a magnetic workpiece, the device comprising a sensor for detecting mechanical stresses on the workpiece and a controller for processing measured values suitable for generating a calibration function for the purpose of correcting a measurement of an externally introduced mechanical stress.

The measuring device can be embodied as independent, be part of a machining system for the workpiece, such as a lathe for example, or a machine for performing the final surface treatment or be part of a simulator. The sensor can detect both internal and external mechanical stresses. From measurements of the internal mechanical stresses or frozen stresses, the controller generates a calibration function by means of which the measurement of an externally introduced mechanical stress is corrected.

The sensor can be a magnetoelastic sensor. A magnetoelastic sensor is based on the measurement of the change in magnetic permeability. This sensor can be used for example as a torque sensor which is able to measure the power transmitted by shafts, for example. A magnetostrictive sensor can also be used.

The sensor can be arranged on a multi-axis system, such that the sensor can be set at a distance from the workpiece or along the workpiece and/or be adjusted in terms of its orientation. In this way the possibilities afforded by the sensor and the properties of the workpiece can be optimally coordinated with one another.

The measuring device can include a device for applying a torque to the workpiece. This enables a load to be applied to the workpiece and thus a measurement to be carried out under load. The device can either be part of the measuring device or belong to a processing system that is coupled to the measuring device for example. Alternatively, however, the measuring device can also be part of a machining system, such as a lathe or similar, for example.

The workpiece can be a shaft. In the case of a shaft the use of a magnetoelastic sensor as a torque sensor is particularly suitable.

The invention is described in more detail below with reference to the drawings, in which:

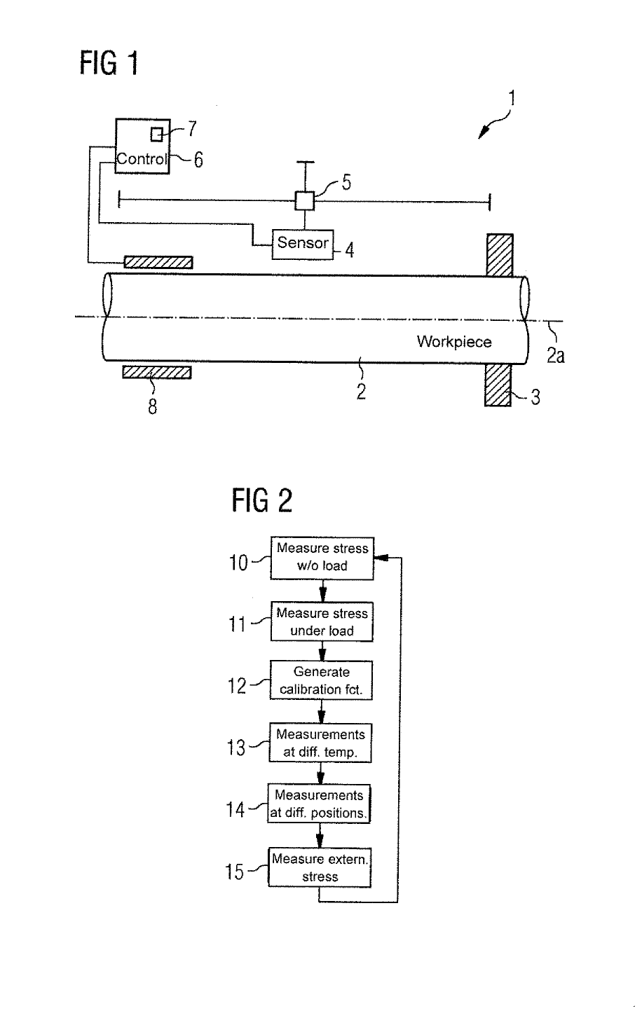

FIG. 1 is a schematic representation of an inventive measuring device for investigating a magnetic workpiece.

FIG. 2 is a flowchart of an inventive method for investigating a magnetic workpiece.

The drawings are intended simply as an aid to explaining the invention and do not limit the latter. The drawings and the individual parts are not necessarily to scale. Like reference signs designate like or similar parts.

FIG. 1 shows a measuring device 1 for investigating a magnetic workpiece 2, in this instance, by way of example, in the form of a shaft, as may be used for example in power stations.

The workpiece 2 is clamped in a workholding device 3 in order to fix the workplace 2 in position. The workplace 2 can be fixed in position in a stationary manner or be moved about an axis of rotation 2a. The measuring device 1 can be an autonomous device, be combined with a machining system or be a component part of the machining system. The machining system can be a lathe or similar, for example.

The workpiece can be investigated by means of a magnetoelastic or magnetostrictive sensor 4, such as in a power measurement or a material evaluation, for example. A magnetoelastic sensor is based on the measurement of the change in magnetic permeability. This sensor can be used for example as a torque sensor which can measure the power transmitted by shafts, for example.

The sensor 4 is mounted on a multi-axis system 5 by means of which the sensor 4 can be moved along the workpiece 2, in other words parallel to the axis of rotation 2a, and in the direction of the workpiece 2, in other words vertically with respect to the axis of rotation 2a, in order in this way to be able to reach all areas or at least one or more selected areas of the surface. In addition, the orientation of the sensor 4 can be changed in order thereby to allow for example a constantly plumb-vertical alignment of the sensor 4 onto the respective section of the surface.

The sensor 4 is connected to a controller 6 for processing measured values which is suitable for generating a calibration function 7 for the purpose of correcting a measurement of an externally introduced mechanical stress on the workpiece 2. The controller 6 can also control the workholding device 3, the rotation of the workpiece 2 and functions of a machining system or a simulator. The controller 6 can be implemented as a separate entity or be part of an existing controller, of a lathe for example.

A measurement under load can be performed by means of a device 8 for applying a static torque to the workpiece 2 or a power transmission of the shaft 2 can be simulated. The torque can be applied mechanically or by means of an eddy current, for example.

The method for investigating the workpiece 2 is described with reference to FIG. 2.

In a first step 10, the internal mechanical stresses on the workpiece 2 are measured without load. For that purpose the sensor 4 is moved along the workpiece 2 in order thereby to generate a map of measurement data which covers the entire surface or a certain part thereof. This measurement data is stored in the controller 6.

In a second step 11, the internal mechanical stresses on the workpiece 2 are measured under load. Toward that end the device 8 exerts a static torque on the workpiece 2. The sensor 4 is again moved along the workpiece 2 in order thereby to generate a map of measurement data which covers the entire surface or a certain part thereof. Ideally, the identical measurement points are selected for this second measurement. This measurement data is likewise stored in the controller 6.

In a third step 12, a calibration function 7 is generated by means of the two measurements for at least one measurement point. The calibration function 7 can include a map of the frozen stresses. The calibration function 7 provides information relating to the internal mechanical or frozen stresses of the workpiece 2 at each location or measurement point. The value of the internal stress can be represented as an offset, which in the ensuing measurement of an externally introduced mechanical stress is then subtracted from the then obtained measurement result. It is also possible to input the individual calibration parameters into the measurement system and take them directly into account in the measurement, i.e. without generating any special calibration function, but effectively using a calibration function indirectly contained in the measurement function.

In a fourth step 13, the measurements for generating the calibration function 7 are performed at different temperatures. In this way the calibration function 7 can also compensate for different temperatures for example for different operating states.

In a fifth step 14, measurements for generating the calibration function 7 are carried out at different positions of the sensor 4 for the measurement. In this way the distance dependence of the sensor 4 with respect to the workpiece 2 can additionally be corrected by the calibration function 7.

The two steps 13 and 14 are optional. Both steps can be measured with and/or without load. The measurement results of steps 10 to 14 are stored in the controller 6 and merged to derive a calibration function 7.

In a sixth step 15, an externally introduced mechanical stress is measured at the at least one measurement point while taking the calibration function 7 into account. The mechanical stress can be applied for example by the device 8 or another device, for example a simulator.

In the sixth step, defects in the material of the workpiece 2 can be detected either in addition to or instead of the measurement of the externally introduced mechanical stress. The defects, such as pinholes for example, can be identified on the basis of changes in the slope of the calibration curve. A material investigation takes place in this way.

The method is well suited for performing measurements on shafts for transmitting power. In said power measurement on shafts, in a power station for example, the calibration of the sensor 4 is effected by means of a mapping of the stresses over the circumference in the region in which the sensor 4 is to be positioned. This can happen in a special measuring device in which the shaft is clamped, or already on the machining system by means of which the final surface treatment of the shaft is performed.

For the measurement, the torque sensor 4 is mounted on the shaft and the placement along and in the direction of the shaft is performed by way of a multi-axis system 5. In order to apply a load to the shaft, the measuring device or the machining system is equipped with a device which simulates the power transmission in the power station, by applying a static torque for example. The cartographed measured values are then imported or entered into an evaluation software program. The calibration parameters can accordingly be set through specification of the position of the sensor 4, the distance from the shaft and the temperature.

What is claimed is:

1-13. (canceled)

14. A method for investigating a magnetic workpiece constructed as a shaft for transmitting power, the method comprising:
measuring internal mechanical stresses on the workpiece without an applied load;
measuring internal mechanical stresses on the workpiece with an applied load;
generating from the internal mechanical stresses measured with and without an applied load a calibration function for at least one measurement point; and
measuring with a magnetoelastic sensor an externally introduced mechanical stress at the at least one measurement point while taking the calibration function into account,
wherein the calibration function comprises a map of the internal mechanical stresses along a periphery of the shaft.

15. The method of claim 14, wherein the calibration function comprises a calibration curve.

16. The method of claim 15, wherein defects in the material of the workpiece are detected based on a slope of the calibration curve.

17. The method of claim 14, wherein the calibration function is generated based on measurements performed at different temperatures.

18. The method of claim 14, wherein the calibration function is generated based on measurements performed at different positions of a measurement sensor.

19. The method of claim 14, wherein at least one of a position of a measurement sensor, a spacing of the measurement sensor from the workpiece and a temperature are specified for measuring the externally introduced mechanical stress.

20. A measuring device for analyzing a magnetic workpiece constructed as a shaft for transmitting power, the device comprising
a magnetoelastic sensor for measuring mechanical stresses on the workpiece; and
a controller configured to process measured values and to generate a calibration function for correcting a measurement of an externally introduced mechanical stress, wherein the calibration function comprises a map of the internal mechanical stresses along a periphery of the shaft.

21. The measuring device of claim 20, wherein the sensor is arranged on a multi-axis system.

22. The measuring device of claim 20, further comprising a device for applying a torque to the workpiece.
